(19) United States
(12) Patent Application Publication
(10) Pub. No.: US 2013/0290591 A1
(43) Pub. Date: Oct. 31, 2013

(54) DOCKING STATION FOR COMPUTERIZED BILL PRESENTER SYSTEM

(71) Applicants: Aron SCHWARZKOPF, Boston, MA (US); Sebastian CASTRO, Boston, MA (US)

(72) Inventors: Aron SCHWARZKOPF, Boston, MA (US); Sebastian CASTRO, Boston, MA (US)

(73) Assignee: LEAF HOLDINGS, INC., Cambridge, MA (US)

(21) Appl. No.: 13/870,388

(22) Filed: Apr. 25, 2013

Related U.S. Application Data
(60) Provisional application No. 61/638,225, filed on Apr. 25, 2012.

(51) Int. Cl. G06F 1/16

(52) U.S. Cl. CPC G06F 1/1632
USPC 710/303

(57) ABSTRACT

Embodiments described herein generally relate to a docking station which can serve as a self-contained mobile and cloud connected communication system. In some embodiments, a docking station includes a docking portion that defines a recess configured to removably receive a portion of a computerized bill presenter. The docking station also includes a charging mechanism disposed in the docking station, which is coupleable to the computerized bill presenter. The charging mechanism is configured to charge a power source disposed in the computerized bill presenter and is also configurable to provide two-way communication between the docking station and the computerized bill presenter. The docking station also includes a communications module configured to provide wireless two-way communication between the docking station and a host device over a network and between the docking station and the one or more computerized bill presenters over the network.

### CROSS REFERENCE TO RELATED APPLICATIONS

This application claims priority to and the benefit of U.S. Provisional Application No. 61/638,225 filed Apr. 25, 2012, the disclosure of which is hereby incorporated by reference in its entirety.

### BACKGROUND

Embodiments described herein generally relate to a docking station that can serve as a self-contained mobile and cloud connected communication system. The docking station can be used for receiving or more computerized bill presenters that can present a bill to an entity such as, for example, a patron of a dining or retail establishment.

The retail industry is highly competitive and often survival of business depends on providing customers with the utmost quality service in an efficient and effective way. Some known businesses, however, struggle to execute efficient and effective methods for providing service to patrons. In some cases, verbal orders can be misunderstood, annotated incorrectly, or misinterpreted by the staff. Paper bills run the risk of being miscalculated or misprinted, present challenges for customers wishing to split the bill among multiple parties, as well as for collecting feedback.

Another aspect of service and quality that some known businesses aim to achieve is the overall customer experience. Customers often have to wait in check out lines to buy even a single piece of merchandise from retail outlets. Reducing the time spent in the store by bringing checkout service to the customer at any location within a retail outlet can greatly increase the efficiency of a business and also create value for the customer.

Thus, a need exists for improved systems and methods for a computerized bill presenting system that allows service and/or retail merchants to economize their costs, keep track of sales, chart sales trends over time, while improving their overall customer experience. Such a communication system can be integrated with social networking platforms such as, for example, Facebook®, Twitter®, Yelp®, or Google+®, in order to allow merchants to keep track of customer spending habits, and provide customers with personalized instant gratification at point of sales such as, for example, discounts, rewards, and/or the like.

### SUMMARY

Embodiments described herein generally relate to a docking station which can serve as a self-contained mobile and cloud connected communication system. In some embodiments, a docking station includes a docking portion that defines a recess configured to removably receive a portion of a computerized bill presenter. The docking station also includes a charging mechanism disposed in the docking station, which is coupleable to the computerized bill presenter. The charging mechanism is configured to charge a power source disposed in the computerized bill presenter and is also configurable to provide two-way communication between the docking station and the computerized bill presenter. The docking station also includes a communications module configured to provide wireless two-way communication between the docking station and a host device over a network and between the docking station and the one or more computerized bill presenters over the network.

In some embodiments, the communications module is configurable to provide two-way communication between the docking station and a hose device over a first network. The communication module is also configurable to provide two-way communication between the docking station and one or more computerized bill presenters over a second network. The second network can include security protocols sufficient to only allow communication between the docking station and the one or more computerized bill presenters over the second network. In some embodiments, the communication module is also configurable provide a third network which includes a geofencing network, configured to define a geofencing perimeter surrounding the docking station.

### BRIEF DESCRIPTION OF THE DRAWINGS

FIG. 1 is a schematic block diagram of a docking station, according to an embodiment.

FIG. 2 is a perspective view of a docking station, according to an embodiment.

FIG. 3 is a top view of the docking station of FIG. 2.

FIG. 4 is an exploded view of the docking station of FIG. 2.

FIG. 5 is a perspective view of a docking station configured to receive multiple computerized bill presenters, according to an embodiment.

FIG. 6 is a top view of the docking station of FIG. 5.

FIG. 7 is an exploded view of the docking station of FIG. 5.

FIG. 8 is a schematic illustration of a communication system, according to an embodiment.

### DETAILED DESCRIPTION

The retail industry is highly competitive and often survival of a business depends on providing customers with the utmost quality of service in an efficient and effective way. Systems that allow service and/or retail merchants to economize their costs, while improving their overall customer experience are paramount to maintaining a successful establishment. Ensuring that orders are placed correctly and that billing is handled precisely and conveniently is essential to promoting customer satisfaction and increasing brand loyalty. In some instances a computerized bill presenter is used to enable convenient point-of-sale operations (e.g., order taking, inventory management, etc.) to increase customer satisfaction in retail outlets such as, for example, restaurants. Examples of such a computerized bill presenter are described in U.S. patent application Ser. No. 13/342,492, entitled “Apparatus and Systems of a Computerized Bill Presenter System”, the disclosure of which is incorporated herein by reference in its entirety.

In some embodiments, a single retail outlet can use multiple computerized bill presenters to take orders from customers and/or present bills for goods or services to customers. The transaction information from each computerized bill presenter system can be communicated securely to a host device, such as, for example, a local computer or a remote server for storage and analysis. Embodiments described herein generally relate to a docking station which can serve as a computerized self contained mobile and cloud connected communication system. The docking station described herein serves as a communications hub for each of the plurality of computerized bill presenters employed at a retail facility. The docking station can be configured to: i) provide two-way communication between the docking station and one or more computerized bill presenters over a dedicated secure network, thereby maintaining customer security; ii) provide an ergonomic charging and docking station for receiving one or more computerized bill presenters; iii) recognize known patrons of the retail establishment within a geofenced perimeter defined by the docking station and communicate notifications to the patron, thereby attracting the patron to the retail outlet; iv) serve as a wireless “hotspot” extending the communication range of one or more computerized bill presenters.

In some embodiments, a docking station includes a docking portion that defines a recess configured to removable receive a portion of a computerized bill presenter. The docking station also includes a charging mechanism disposed in the docking station, which is coupleable to the computerized bill presenter. The charging mechanism is configured to charge a power source disposed in the computerized bill presenter and also provide two-way communication between the docking station and the computerized bill presenter. The docking station also includes a communications module configured to provide wireless two-way communication between the docking station and a host device over a network. The communications module is further configured to provide wireless two-way communication between the docking station and the one or more computerized bill presenters over the network.

In some embodiments, a docking station includes a docking portion which includes a recess configured to removably receive a portion of a computerized bill presenter. A charging mechanism is disposed in the docking station and is configured to be electrically coupleable to the computerized bill presenter and charge a power source disposed in the computerized bill presenter. The charging mechanism is also configurable to provide two-way communication between the docking station and the computerized bill presenter. The communication system further includes a communication module configured to provide two-way communication between the docking station and a first network. The communication system is also configured to provide two-way communication between one or more computerized bill presenters and the docking station over a second network. The second network includes security protocols configured to only allow communication between the one or more computerized bill presenters and the docking station over the second network.

In some embodiments, a communication system includes a docking station which includes a recess configured to removably receive a portion of a computerized bill presenter. A charging mechanism is disposed in the docking station and is configured to be electrically coupleable to the computerized bill presenter to charge a power source disposed in the computerized bill presenter. The charging mechanism is also configurable to provide two-way communication between the docking station and the computerized bill presenter. The communication system includes a communications module disposed in the docking station which is configured to provide two-way communication between the docking station and first network. The communications module is also configured to provide two-way communication between one or more computerized bill presenters and the docking station over a second network. The second network includes security protocols configured to only allow communication between the one or more computerized bill presenters and the docking station over the second network. The communications module is further configured to provide a third network which includes a geofencing network such that the geofencing network defines a geofenced perimeter surrounding the docking station. In some embodiments, the geofencing network is configured to recognize a known patron of the retail outlet within the geofenced perimeter and communicate notifications to the known patron.

As used in the specifications, the singular forms “a”, “an” and “the” include plural referents unless the context clearly dictates otherwise. Thus, for example, the term “a network” is intended to mean a single network or a combination of networks.

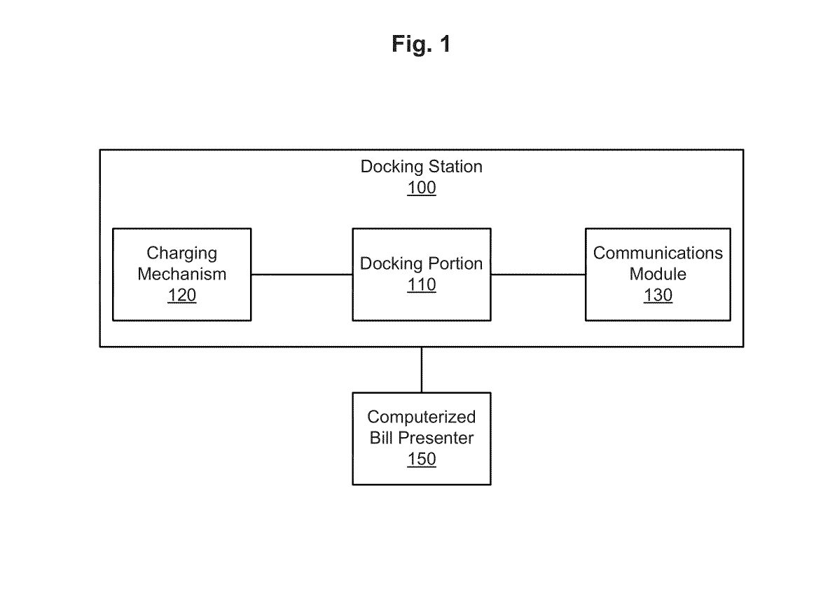

FIG. 1 is a schematic block diagram of a docking station 100 configured to removably receive a computerized bill presenter 150. The docking station 100 includes a docking portion 110, a charging mechanism 120 and a communications module 130. The docking station 110 includes a housing (not shown) that defines an internal region within which the charging mechanism 120, and the communications module 130 are disposed.

The docking portion 110 includes a recess configured to removably receive a portion of the computerized bill presenter 150. The docking portion 110 also includes a docking member (not shown) disposed in the internal region defined by the housing. In some embodiments, the docking member can be coupled to a bottom portion of the recess. The docking portion 110 can be inclined at an angle, for example, about 15-60 degrees, and can be configured to receive at least a portion of the computerized bill presenter 150. The housing can also include a plurality of guide members, for example, to ensure proper alignment of the computerized bill presenter 150 with the recess and the docking member. The docking member can include a plurality of alignment features on a surface of the docking member. The alignment features can, for example, allow the docking portion 110 to receive the computerized bill presenter 150 only in a predetermined orientation. In some embodiments, the docking member can also include apertures for receiving at least a portion of the charging mechanism 120, for example, electrical couplings (not shown) included in the charging mechanism 120. In some embodiments, the docking station 100 can be configured to include a plurality of docking portions 110, for example, 10 docking portions, such that each docking portion 110 is configured to receive a single computerized bill presenter 150. The docking station 100 can be mounted on a swivel base configured to allow 360 degree rotation of the docking station 100 about the swivel base. In such embodiments, the docking station 100 can also include a locking mechanism and a release mechanism. In some embodiments, a counter weight can be disposed inside the docking station 100 to lower a center of gravity of the docking station 100 and prevent the docking station 100 from tipping over when a computerized bill presenter 150 is coupled to the docking station 100.

In some embodiments, the docking station 100 can include a memory for storing information such as, for example, a status information of the computerized bill presenter 150, a transaction history of the computerized bill presenter 150, and/or an identification code of the computerized bill presenter 150. The docking station 100 can include a display configurable to convey to the user a status of the docking station 100, for example, docking station ON/OFF, battery power remaining, network connectivity status, and notifications (e.g., HELLO!, “Computerized Bill Presenter #1234 Detected”, “Data Sync Complete”, etc.). The docking station 100 can also include a user input interface, for example, a button, an alpha-numeric keypad, or a touch screen, configured to allow the user to input various commands such as, for example, power ON/OFF docking station 100, input any retail transaction information, and/or program the docking station 100.

The charging mechanism 120 can include a printed circuit board and electrical couplings for reversibly coupling the computerized bill presenter 150. The charging mechanism 120 can be disposed in the housing of the docking station 100 such that at least a portion of the charging mechanism 120, for example, the electrical couplings are disposed in the docking portion 110 (e.g., apertures defined in the docking member of the docking portion 110). In some embodiments, the electrical couplings can be mechanical couplings which physically contact electrical contacts included in the computerized bill presenter 150 and transfer a predetermined electrical current to a rechargeable power source disposed in the computerized bill presenter 150. In some embodiments, the electrical couplings can be contact-less induction couplings. In such embodiments, there can be a small clearance between the electrical couplings and the electrical contacts of the computerized bill presenter 150. The charging mechanism 120 can also include additional electronic components such as, for example, transistors, capacitors, resistors, amplifiers, and the likes. In some embodiments, the charging mechanism 120 can also be configured to receive and/or convey electronic information between the computerized bill presenter 150 and the docking station 100, for example, retail transaction information, software and/or firmware updates.

The communications module 130 can be disposed in the docking station 100 and is configured to provide two-way communication between the docking station 100 and a first network. The first network can include, for example, a local area network (LAN), a wide area network (WAN), a personal area network (PAN), a virtual network, a telecommunications network, and the internet. A host device (not shown), that can include, for example, a mobile phone app, a tablet app, a local computer, and/or a server can also be in two-way communication with the first network. The communications module 130 can thereby communicate retail transaction information to the host device over the first network for storage and analysis, for example, number of transactions per day, number of transactions per month, sales trends, profits, customer reviews, areas of improvement, etc.

The communications module 130 can further be configured to provide two-way communication between the docking station 100 and one or more computerized bill presenters 150 over a second network. The second network can include security protocols sufficient to only allow communication between the docking station 100 and the one or more computerized bill presenters 150 over the second network. For example, the second network can include a secured local area network, a secured personal area network, and a secured virtual local area network. The security protocols can include, for example, SSL/TLS, IPsec, SSH, AES, 3DES, IDEA, S-HTTP, or a combination thereof. The docking station 100 can be operative to communicate with the first network and/or the second network using any suitable communication link, for example, a USB, firewire, DSL, Bluetooth®, low powered Bluetooth®, and/or Wi-Fi. In some embodiments, the docking station 100 can include a cellular service receiving (e.g., 3G, 4G, LTE) unit configured to allow the docking station 100 to communicate with the first and/or the second network via a cellular service. The cellular service receiving unit can be configured to create a wireless “hotspot” to provide wireless connectivity to one or more computerized bill presenters 150 over a cellular service, when the cellular service receiving unit is in communication with the cellular service. In some embodiments, the docking station 100 can also include a near field communication (NFC) device, for example, an RFID device, to communicate with an NFC device of one or more computerized bill presenters 150 associated with the docking station 100. The docking station 100 can be configured to use NFC communication to determine a distance of the one or more computerized bill presenters 150 from the docking station 100, and alert a user (e.g., using audio, visual or tactile alerts) if the one or more computerized bill presenters 150 are beyond a certain predetermined distance from the docking station 100.

In some embodiments, the communications module 130 can also be configured to provide a third network. The third network can be a geofencing network configured to define a geofenced perimeter to a predetermined radial distance, for example, 10 meters, 20 meters, 30 meters, or any other suitable distance, surrounding the docking station 100. In some embodiments, the communications module 130 can include a global positioning system (GPS) unit, which is configured to provide the geofencing network. The geofencing network can be configured to recognize a known patron of the retail outlet within the geofenced perimeter, and communicate notifications to the known patron. The notifications can include, for example, daily promotions, specials, discounts, rewards and/or coupons, available in the retail establishment at a given time. Such notifications can be communicated to the known patron using email, text message, Facebook® message or update, Twitter® feed, or Google+® alert.

Having described above various general principles, several exemplary embodiments of these concepts are now described. These embodiments are only examples, and many other configurations of a docking station for receiving a computerized bill presenter are envisioned.

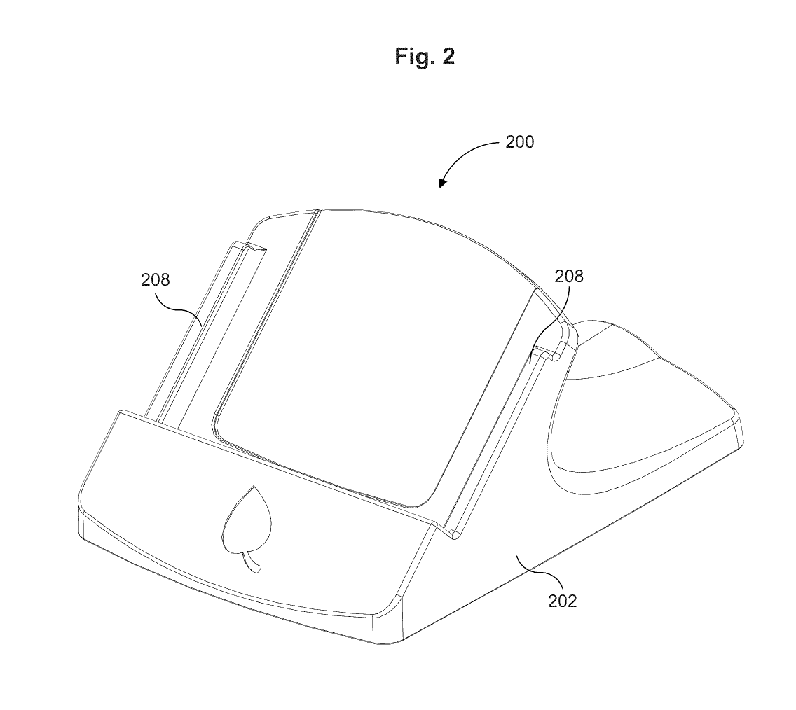

Referring now to FIGS. 2-4, a docking station 200 for receiving a computerized bill presenter can include a docking portion 210 and a charging mechanism 220. The docking station 200 can also include a communications module (not shown), for example, for two-way communication with one or more networks.

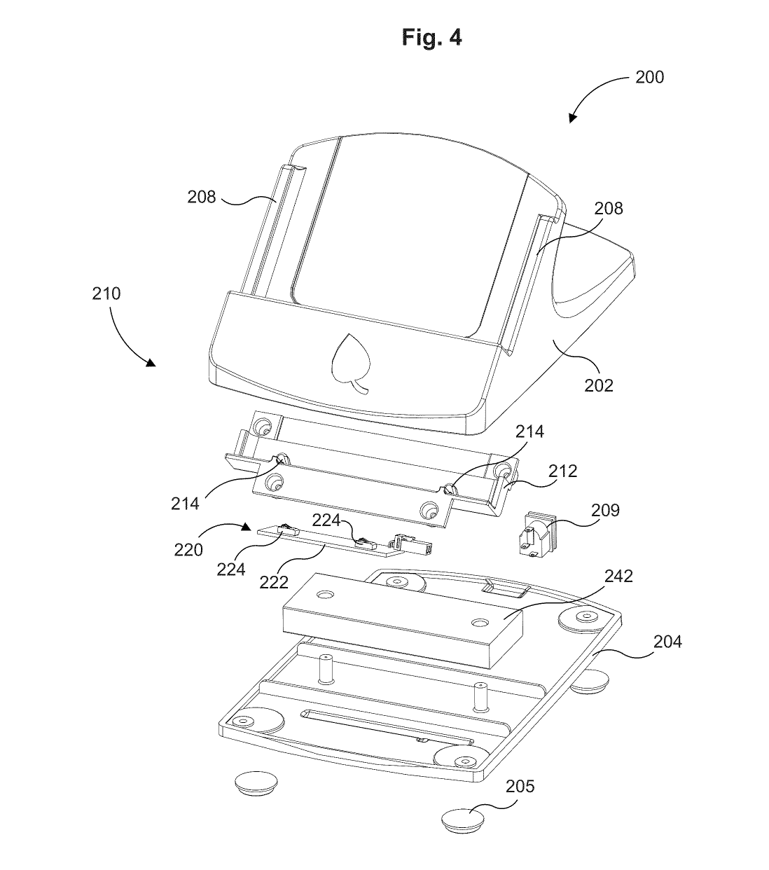

As shown in FIG. 4, the docking station 200 includes a housing 202 that is coupled to a base 204. The housing 202 and the base 204 can be coupled together using any suitable method, for example, via a set of screws and mounting apertures, bolted, riveted, glued, hot welded, or snap-fit. The housing 202 and the base 204 together define an internal region within which the charging mechanism 220 and the communications module can be disposed. The housing 202 can be of any shape, size or configuration. The housing 202 and the base 204 can be made from a substantially light weight and rigid material, for example, plastics. The housing 202 can be smooth and substantially free of sharp edges. The base 204 is substantially flat such that the docking station 200 can be disposed on a flat surface. A plurality of pads 205 are disposed on a bottom surface of the base 204. The pads 205 can be formed from any soft and high friction material, for example, rubber or silicone. The pads can, for example, define a frictional contact with the surface on which the docking station 200 is placed, thereby, reducing the likelihood of the docking station 200 sliding on the surface.

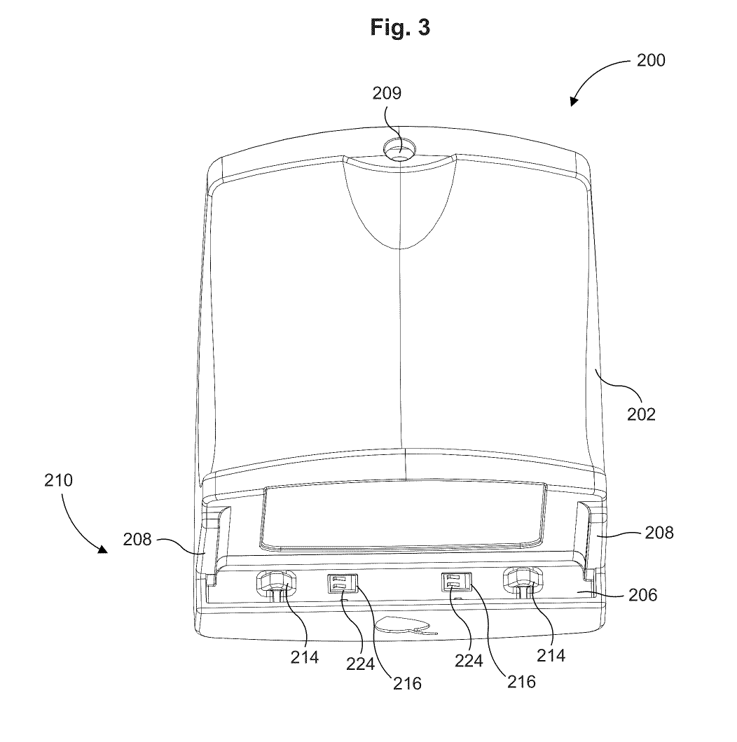

As shown in FIGS. 2-4, the dock portion 210 includes an angular portion that includes a recess 206 (FIG. 3) configured to receive a portion of the computerized bill presenter. The housing 202 includes guide members 208 to ensure proper alignment of the computerized bill presenter with the recess 206. An electrical socket 209 is disposed in the housing 202, such that the electrical socket is accessible from a backside of the housing 200. The electrical socket 209 can be operably coupled to an electrical source (e.g., a 110 V, 60 Hz outlet) to receive a flow of current. In some embodiments, the docking station 200 can include an electrical plug and/or electrical wire configured to couple the electrical socket 209 to receive a plug, wire and/or any other suitable connection. In this manner, the electrical socket 209 can function similar to known electrical sockets or connections to provide flow of current to the electrical components included in the docking station 200.

The docking portion 210 includes a docking member 212 as shown in FIG. 4. The docking member 212 can be coupled to the housing 202 such that at least a portion of the docking member 212 forms a base of the recess 206, as shown in FIG. 3. The docking member 212 can be coupled to the housing 202 using any suitable means, for example, screwed, bolted, riveted, glued, hot-welded or snap-fit. The docking member 212 can be made from a light weight and rigid material, for example, plastics. The docking member 212 includes a plurality of alignment features 214, which can be configured to mate with alignment features on the computerized bill presenter. The alignment features 214 can be configured to ensure that the computerized bill presenter can be received by the docking station 200 only in a preferred orientation, for example, a display of the computerized bill presenter facing a user. The docking member 212 also includes a plurality of apertures 216 configured to receive at least a portion of the charging mechanism 220.

The charging mechanism 220 includes a printed circuit board (PCB) 222 that has a plurality of electrical couplings 224 disposed on it. In some embodiments, at least a portion of the electrical couplings 224 can be disposed in the apertures 216 defined by the docking member 212, when the charging mechanism 220 is coupled to the docking portion 210. In this manner, when the computerized bill presenter is coupled to the docking portion 210, the charging mechanism 220 can transfer a portion of a flow of current to the computerized bill presenter, thereby, charging a power source disposed in the computerized bill presenter. In some embodiments, the electrical couplings 224 can include a plug, socket, contact or contacts for mechanically engaging a charging unit of the computerized bill presenter. In some embodiments, the electrical couplings 224 can be contact-less induction couplings, which use electromagnetic fields to communicate electrical power to the computerized bill presenter. In such embodiments, there can be a slight gap between the charging mechanism 220 and the charging unit of the computerized bill presenter that can allow the inductive coupling and charging to occur. In some embodiments, the charging mechanism 220 can also allow the docking station 200 to communicate with the computerized bill presenter, for example, allow two-way communication of digital information between the computerized bill presenter and the docking station 200.

While not shown in FIG. 2-4, the docking station 200 can include any suitable electrical components operative to the functioning of the docking station 200. For example, the docking station 200 can include a set of wires configured to electrically couple the electrical socket 209 to the charge member 220. In some embodiments, the electrical socket 209 and/or the charging mechanism 220 can include plugs or pins configured to couple to an electrical wire and/or connector. In some embodiments, the docking station 200 can include additional input/output ports for connection other peripherals (e.g., a printer, a bar code scanner, a camera, etc.) to the docking station 200.

The communications module can be disposed in the docking station 200 and is configured to provide two-way communication between the docking station 200 and a first network. The first network can include, for example, a local area network (LAN), a wide area network (WAN), a personal area network (PAN), a virtual network, a telecommunications network, and the internet. The first network can allow the docking station to communicate with different peripheral devices, for example, host device and printers. The host device can include, for example, a mobile phone app, a tablet app, a local computer, and/or a server can also be in two-way communication with the first network. The communications module can, for example, communicate retail transaction information to the host device over the first network for storage and analysis, for example, number of transactions per day, number of transactions per month, sales trends, profits, customer reviews, areas of improvement, etc. In some embodiments, the communications module can also be configured to communicate with wireless printers over the first network, for example, to implement wireless printing from different computers in an enterprise to one centrally available printer. In such embodiments, the printer can be plugged into a USB port (not shown) included in the docking station 200, and added to the printer list on all the computers in an enterprise. This can help reduce overall costs in running an enterprise.

The communications module can further be configured to provide two-way communication between the docking station 200 and one or more computerized bill presenters over a second network. The second network can include security protocols sufficient to only allow communication between the docking station 200 and the one or more computerized bill presenters over the second network. For example, the second network can include a secured local area network, a secured personal area network, and a secured virtual local area network. The security protocols can include, for example, SSL/TLS, IPSec, SSH, AES, 3DES, IDEA, S-HTTP, or a combination thereof. The docking station 200 can be operative to communicate with the first network and/or the second network using any suitable communication link, for example, a USB, firewire, DSL, Bluetooth®, low powered Bluetooth®, and/or Wi-Fi. In some embodiments, the communications module can be configured to plug into an Ethernet hard line. In such embodiments, the docking station 200 can provide a wireless access point when connected to an Ethernet network, and can be used as an Ethernet-to-wireless bridge under certain wireless configurations. In some embodiments, the communications module can be configured to extend the range of a wireless network, for example, when a retail or sales establishment has a preexisting wireless network. In such embodiments, once the communications modules is configured to the existing wireless service, the docking station 200 can be unplugged and placed anywhere in the retail or sales establishment to extend wireless connectivity to areas previously inaccessible to wireless service such as, for example, an outdoor patio of a restaurant. In some embodiments, the docking station 200 can include a cellular service (e.g., 3G, 4G, LTE) receiving unit configured to allow the docking station 200 to communicate with the first and/or the second network via a cellular service. The cellular service receiving unit can be configured to create a wireless hotspot to provide wireless connectivity to the one or more computerized bill presenters when the cellular service receiving unit is in communication with the cellular service.

In some embodiments, the docking station 200 can also include a near field communication (NFC) device, for example, an RFID device, to communicate with a NFC device of one or more computerized bill presenters associated with the docking station 200. The docking station 200 can be configured to use NFC communication to determine a distance of the one or more computerized bill presenters from the docking station 200, and alert the user (e.g., using audio, visual or tactile alerts) if the one or more computerized bill presenters are beyond a certain predetermined distance from the docking station 200.

In some embodiments, the communications module can also be configured to provide a third network. The third network can be a geofencing network configured to define a geofenced perimeter to a predetermined radial distance, for example, 10 meters, 20 meters, 30 meters, or any other suitable distance, surrounding the docking station 200. In some embodiments, the communications module can include a global positioning system (GPS) unit, which is configured to provide the geofencing network. A geofence is a virtual perimeter for a real-world geographic area and an advantage of using this feature can be, for example, when a known patron of a restaurant drives into the geofenced perimeter around the retail establishment, the docking station 200 and/or the computerized bill presenter can detect the patron's presence using the GPS system (e.g., through a known mobile device associated with the patron), and can communicate a text message, email, Facebook®, Twitter®, or Google+® notification to the patron informing them about specials (e.g., food or drink specials), promotion, rewards, coupons, and/or discounts available at the retail or sales establishment at that time. This can potentially attract the patron to use the services of the enterprise, and can increase sales and revenue of the enterprise.

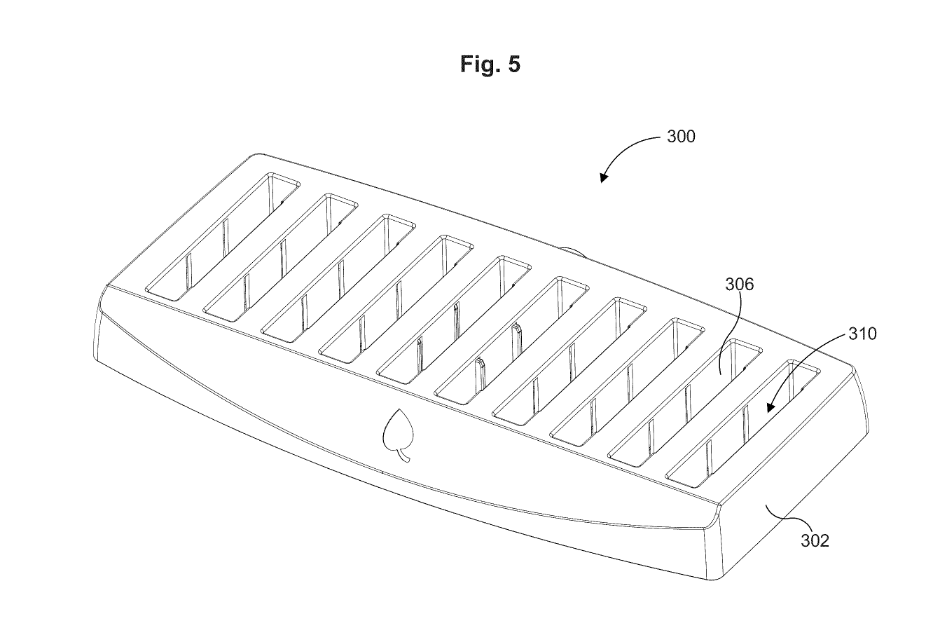

In some embodiments, the docking station can include a plurality of docking portions such that each docking portion is configured to receive a single computerized bill presenter. Referring now to FIGS. 5-7, a docking station 300 includes a plurality of docking portions 310, a plurality of charging mechanisms 320 and a communications module (not shown). The communications module can be substantially similar in structure and function to the communications module described with respect to FIGS. 2-4 and is therefore not described here in further detail.

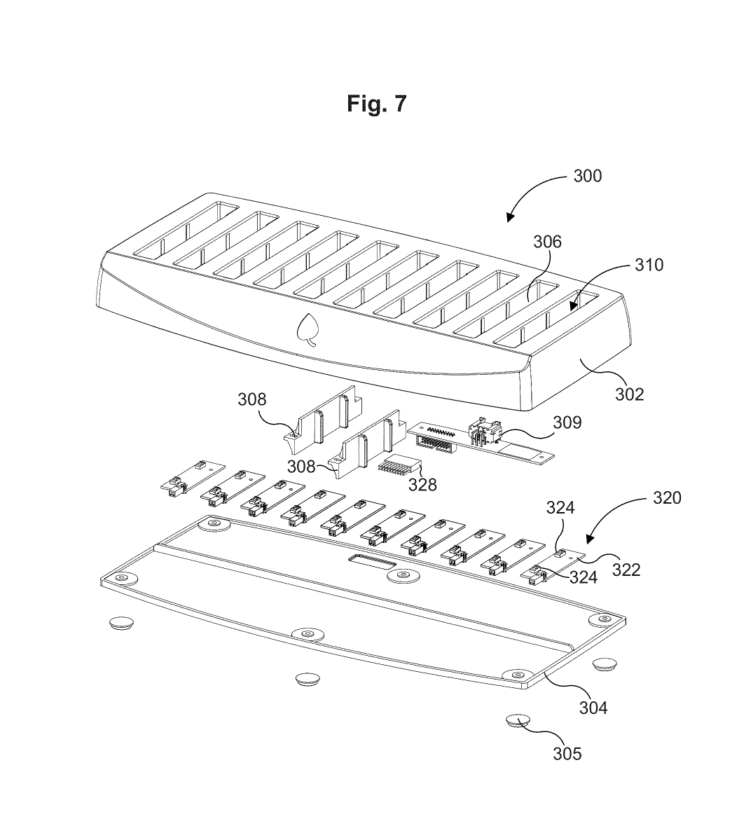

As shown in FIG. 7, the docking station 300 includes a housing 302 that is coupled to a base 304. The housing 302 and the base 304 can be coupled together using any suitable method, for example, via a set of screws and mounting apertures, glued together, or snap-fit. The housing 302 and the base 304 together define an internal region within which the plurality of charging mechanisms 320 and the communications module can be disposed. The housing 302 can be of any shape, size or configuration. The housing 302 and the base 304 can be made from a substantially light weight and rigid material, for example, plastics. The housing 302 can be smooth and substantially free of sharp edges. The base 304 is substantially flat such that the docking station 300 can be disposed on a flat surface. A plurality of pads 305 are disposed on a bottom surface of the base 304. The pads 305 can be formed from any soft and high friction material, for example, rubber or silicone. The plurality of pads 305 can, for example, define a frictional contact with the surface on which the docking station 300 is placed, thereby, reducing the likelihood of the docking station 300 sliding on the surface.

As shown in FIGS. 5-7, the housing 302 includes a plurality of docking portions 310. Each of the plurality of docking portions 310 includes a recess 306, such that each recess 306 is configured to receive a single computerized bill presenter. A plurality of guide members 308 are disposed on the base 304, configured to allow proper alignment of the housing 302 to the base 304. In some embodiments, the guide members 308 can be optionally configured to snap-fit into grooves, notches, indents, or the likes of the housing 302. This can, for example, make it easier to couple the housing 302 to the base 304 using more secure means (e.g., screws, bolts, rivets, glue, etc.). An electrical socket 309 is disposed in the housing 302, such that the electrical socket 309 is accessible from a backside of the docking station 300. The electrical socket 309 can be operably coupled to an electrical source (e.g., a 110 V, 60 Hz outlet) to receive a flow of current. In some embodiments, the docking station 300 can include an electrical plug and/or electrical wire configured to couple the electrical socket 309 to receive a plug, wire and/or any other suitable connection. In this manner, the electrical socket 309 can function similar to known electrical sockets or connections to provide flow of current to the electrical components included in the docking station 300. The electrical socket 309 can further include electronic couplings to distribute electrical power to each of the plurality of charging mechanisms 320.

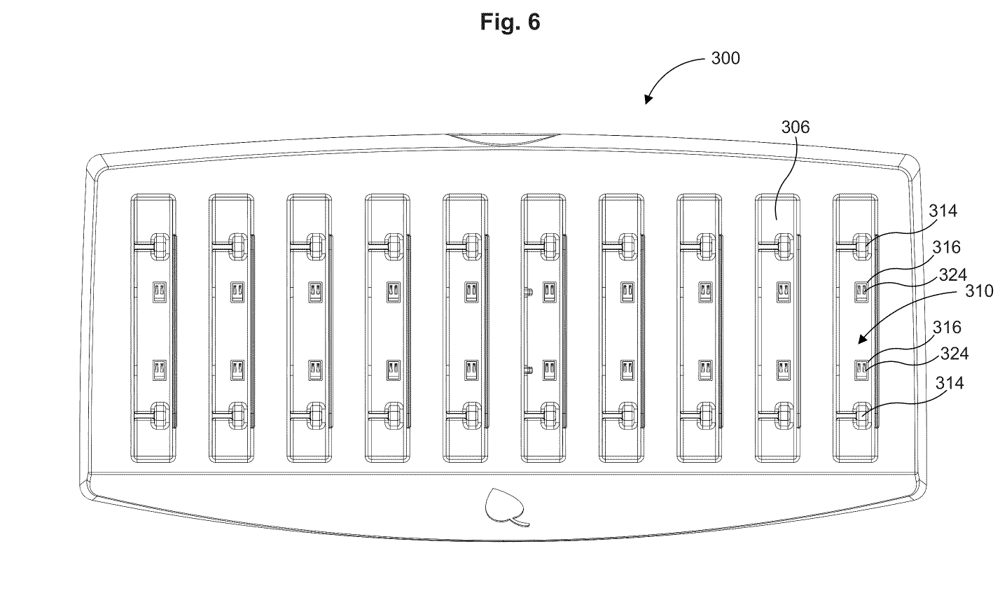

Each of the plurality of docking portions 310 is configured to receive a single computerized bill presenter in a vertical orientation. In some embodiments, each of the plurality of docking portions 310 can be a separate member that can be coupled to the housing 302 using any suitable means, for example, screwed, bolted, riveted, glued or hot welded. In some embodiments, each of the plurality of docking portions 310 can be monolithically formed with the housing, for example, formed in single injection molding process. Each of the plurality of docking portions 310 include a plurality of alignment features 314 (FIG. 6), that can be configured to mate with alignment features on the computerized bill presenter. The alignment features 314 can, thereby, ensure that the computerized bill presenter can be received by the docking station 300 only in a preferred orientation. Each of the plurality of docking portions 310 also includes a plurality of apertures 316 configured to receive at least a portion of the each of the plurality of charging mechanisms 320.

Each of the plurality of charging mechanisms 320 include a printed circuit board (PCB) 322 that has a plurality of electrical couplings 324 disposed on it. In some embodiments, at least a portion of the electrical couplings 324 included in each of the plurality of charging mechanisms 320 can be disposed in the apertures 316 defined by the each of the plurality of docking portions 310, when the plurality of charging mechanisms 320 are coupled to the plurality of docking portions 310. An electrical adapter 328 is also disposed in the housing configured to electrically couple each of the plurality of charging mechanisms 320 to the electrical socket 309. In this manner, when the plurality of computerized bill presenters are coupled to the docking portions 310, the plurality of charging mechanisms 320 can transfer a portion of a flow of current to each of the plurality of computerized bill presenters, thereby, charging a power source disposed in the each of the plurality of computerized bill presenters. In some embodiments, the electrical couplings 324 can include a plug, socket, contact or contacts for mechanically engaging the computerized bill presenter. In some embodiments, the electrical couplings 324 can be contact-less induction couplings, which use electromagnetic fields to communicate electrical power to the user device. In such embodiments, there can be a slight gap between the charging mechanism 320 and the charging unit of the computerized bill presenter that can allow the inductive coupling and charging to occur. In some embodiments, the charging mechanism 320 can also allow the docking station 300 to communicate with the computerized bill presenter, for example, allow two-way communication of digital information between the computerized bill presenter and the communications module.

While not shown in FIG. 5-7, the docking station 300 can include any suitable electrical components operative to the functioning of the docking station 300. For example, the docking station 300 can include a set of wires configured to electrically couple the electrical adapter 320 to each of the plurality of charging mechanisms 320. In some embodiments, the electrical socket 309 and/or each of the plurality of charging mechanisms 320 can include plugs or pins configured to couple to an electrical wire and/or connector.

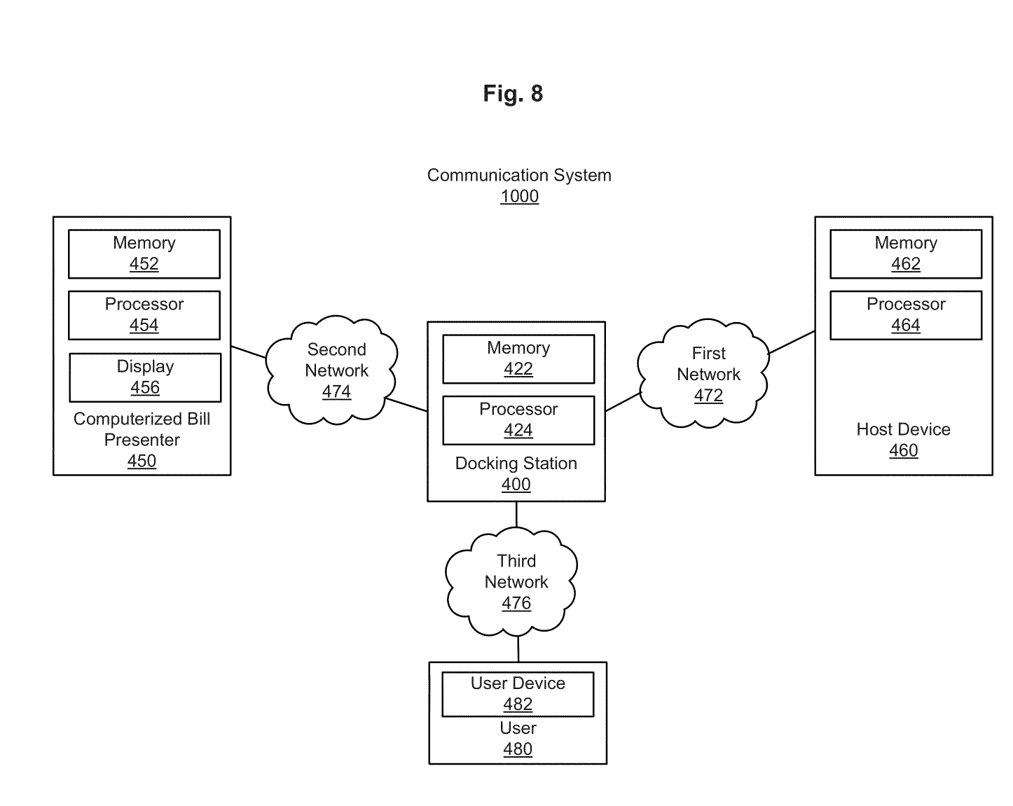

In some embodiments, any one of the docking stations described herein can be included in a communication system. FIG. 8 shows a schematic illustration of a communication system 1000 that includes a docking station 400, a computerized bill presenter 450, and a host device 460, according to an embodiment. The docking station 400 is in two-way communication with the host device 460 over a first network 472 and is also in two-way communication with one or more computerized bill presenters 450 over a second network 474. The docking station 400 is also configurable to provide a third network 476 which includes a geofencing network to communicate notifications to a user 480, for example, a patron of a retail establishment, as described herein.

The docking station 400 can be, for example, a charging station, a breakout dock, a converter dock, a communications dock, and/or a combination thereof, and can include any of the docking stations described herein, for example, docking station 100, 200 or 300. The docking station 400 can include one or more network interface devices (e.g., a network interface card, USB, fire wire, DSL, Bluetooth®, low powered Bluetooth®, or Wi-Fi). The docking station 400 can be configured to include a memory 422 and a processor 424, for example, to store and/or analyze a retail transaction.

The computerized bill presenter 450 can be, for example, a tablet, a personal digital assistant (PDA), a smart phone, and/or the like. The computerized bill presenter 450 can be configured to include a memory 452, a processor 454 and a display 456. While not shown in FIG. 8, the computerized bill presenter 450 can include one or more network interface devices (e.g., network interface card) configured to connect the computerized bill presenter 450 to the network 470. In some embodiments, the computerized bill presenter 450 can be configured to perform point-of-sale operations (e.g., order taking, inventory management, etc.) such as, for example, at a restaurant.

The host device 460 can be any type of device configured to send data over the first network 470 to, and/or receive computerized bill presenter 450 data from the docking station 400. The host device 460 can include a memory 462 and a processor 464. The host device 460 can be, for example, a smart phone, a tablet, a local computer, or a remote server. In some embodiments, the host device 460 can be configured to function as, for example, a server device (e.g., a web server, an application server, a proxy server, a mail server, and/or the like), a network management device, and/or so forth. While not shown in FIG. 8, the host device 460 can include additional hardware and/or software modules that can supply data to and/or receive data from the computerized bill presenter 450 and docking station 400, and execute processes and/or functions associated with such a communication system 1000. In some embodiments, the processor 464 included in the host device 460 can be configured to analyze information including but not limited to computerized bill presenter retail sales information. In such embodiments, the analysis can be used to determine, for example, number of sales per day, volumes of sales per day, break down of sales for each product, inventory remaining, customer satisfaction rating, etc.

The first network 472 can include, for example, a local area network (LAN), a wide area network (WAN), a personal area network (PAN), a virtual network, a telecommunications network, and the internet, and can be implemented as a wired or wireless network. The first network 472 can allow two-way communication of retail transaction information between the docking station 400 and the host device 460, for example, number of transactions per day, number of transactions per month, sales trends, profits, customer reviews, areas of improvement, etc. Similarly, in some embodiments, the host device 460 can communicated information to the docking station 400 including, but not limited to, software updates, firmware updates, notifications such as, for example, specials, promotions and discounts (e.g., to communicate to a patron of the retail outlet). This information can then be communicated by the docking station 400 to the computerized bill presenter 450 over the second network 474 as described herein. In some embodiments, any of the communications described herein can take place at a predetermined time interval. In some embodiments, the communications can be on demand. In some embodiments, the docking station 400 can also be configured to communicate with wireless printers over the first network 472, for example, to implement wireless printing from different computers in an enterprise to one centrally available printer. This can help reduce overall costs in running an enterprise.

The second network 474 includes security protocols sufficient to only allow communication between the docking station 400 and the one or more computerized bill presenters 450 over the second network 474. For example, the second network 474 can include a secured local area network, a secured personal area network, and a secured virtual local area network. The security protocols can include, for example, SSL/TLS, IPsec, SSH, AES, 3DES, IDEA, S-HTTP, or a combination thereof. The docking station 400 can be operative to communicate with the first network 472 and/or the second network 474 using any suitable communication link, for example, a USB, firewire, DSL, Bluetooth®, low powered Bluetooth®, and/or Wi-Fi. In some embodiments, the docking station 400 can be configured to plug into an Ethernet hard line. In such embodiments, the docking station 400 can provide a wireless access point when connected to an Ethernet network, and can be used as an Ethernet-to-wireless bridge under certain wireless configurations. In some embodiments, the docking station 400 can be configured to extend the range of a wireless network, for example, when a retail or sales establishment has a preexisting wireless network. In such embodiments, once the docking station 400 is configured to the existing wireless service, the docking station 400 can be unplugged and placed anywhere in the retail or sales establishment to extend wireless connectivity to areas previously inaccessible to wireless service such as, for example, an outdoor patio of a restaurant. In some embodiments, the docking station 400 can include a cellular service (e.g., 3G, 4G, LTE) receiving unit configured to allow the docking station 400 to communicate with the first network 472 and/or the second network 474 via a cellular service. The cellular service receiving unit can be configured to create a wireless hotspot to provide wireless connectivity to the one or more computerized bill presenters 450 when the cellular service receiving unit is in communication with the cellular service.

The third network 476 can be a geofencing network configured to define a geofenced perimeter to a radial predetermined distance, for example, 10 meters, 20 meters, 30 meters, or any other suitable distance, surrounding the docking station 400. In some embodiments, the docking station 400 can include a global positioning system (GPS) unit, which is configured to provide the geofencing network. When a known user 480 who has a user device 482 associated with the user 480, for example, a mobile phone, a tablet, or a portable computer, enters into the geofenced perimeter, the docking station 400 can detect the user 480 presence using the geofencing functionality of the third network 476. For example, the user device 482 can also include a GPS which can indicate the location of the user device 482. When the location of the user device 482 associated with the known user 480 is determined to be within the geofenced perimeter, the docking station 400 can communicate notifications, for example, specials (e.g., food or drink specials), promotions, rewards, coupons and/or discounts available at the retail or sales establishment at that time via any suitable means, for example, a text message, email, Facebook®, Twitter®, or Google+® alert. This can, for example, serve as a personalized marketing tool and encourage the patron to make purchases at the retail establishment.

While various embodiments of the system, methods and devices have been described above, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

For example, although various embodiments have been described as having particular features and/or combination of components, other embodiments are possible having any combination or sub-combination of any features and/or components from any of the embodiments described herein. In addition, the specific configurations of the various components can also be varied. For example, the size and specific shape of the various components can be different than the embodiments shown, while still providing the functions as described herein.

1. A docking station, comprising:
a docking portion having a recess configured to removably receive a portion of a computerized bill presenter;
a charging mechanism disposed in the docking station and configured to be electrically coupleable to the computerized bill presenter to charge a power source disposed in the computerized bill presenter, the charging mechanism further configurable to provide two-way communication between the computerized bill presenter and the docking station; and
a communications module configured to provide wireless two-way communication between the docking station and a host device over a network, the communications module further configured to provide two-way communication between the docking station and the one or more computerized bill presenters over the network.

2. The docking station of claim 1, the network is at least one of a local area network, a wide area network, a personal area network, a virtual network, a telecommunications network, and the internet.

3. The docking station of claim 1, wherein the two-way communication between any one of the docking station, the computerized bill presenter, and the host device includes at least one of a retail transaction information, customer response, and notifications.

4. A docking station, comprising:
a docking portion having a recess configured to removably receive a portion of a computerized bill presenter;
a charging mechanism disposed in the docking station and configured to be electrically coupleable to the computerized bill presenter to charge a power source disposed in the computerized bill presenter, the charging mechanism further configurable to provide two-way communication between the computerized bill presenter and the docking station; and
a communications module configured to provide two-way communication between the docking station and a first network, the communications module further configured to provide two-way communication between the docking station and one or more computerized bill presenters over a second network, the second network including network security protocols sufficient to only allow communication between the docking station and the one or more computerized bill presenters over the second network.

5. The docking station of claim 4, wherein the communication module is further configured to provide a third network.

6. The docking station of claim 5, wherein the third network is a geofencing network configured to identify a known patron of the restaurant within a geofenced perimeter defined by the geofencing network.

7. The docking station of claim 6, wherein the communications module includes a global positioning system (GPS) unit, the GPS unit configured to provide the geofencing network.

8. The docking station of claim 4, wherein the docking station includes a housing configured to define the recess.

9. The docking station of claim 4, wherein the housing includes a plurality of guide members configured to ensure proper alignment of the user device with the recess.

10. The docking station of claim 4, wherein the docking station includes a plurality of recesses, each of the plurality of dock portion configured to receive a single user device.

11. The docking station of claim 10, wherein the docking station is configured to include 10 dock portions.

12. The docking station of claim 4, wherein the docking station includes a swivel base, the swivel base configured to allow 360 degree rotation of the docking station about the swivel base.

13. The docking station of claim 4, wherein the docking station includes a counter weight disposed in the internal region defined by the housing, the counter weight configured to lower the center of gravity of the dock station and prevent the docking station from tipping over when the user device is coupled to the docking station.

14. The docking station of claim 4, wherein the docking station includes alignment features configured to allow coupling of the user device with the docking station only in a predetermined orientation.

15. The docking station of claim 4, wherein the charging system includes electrical couplings, the electrical couplings configured to reversibly couple to the user device using at least one of a mechanical coupling or contact-less induction coupling.

16. The docking station of claim 4, wherein the docking station includes a memory for storing at least one of a status information of a computerized bill presenter, a transaction history of a computerized bill presenter, and an identification code of a computerized bill presenter.

17. The docking station of claim 4, wherein the docking station includes a display, the display configurable to convey to the user at least one of a docking station ON, docking status OFF, battery power remaining, network connectivity status, and notifications.

18. The docking station of claim 4, wherein the first network is at least one of a local area network, a wide area network, a personal area network, a virtual network, a telecommunications network, and the internet.

19. The docking station of claim 4, wherein the second network is at least one of a secured local area network, a secured personal area network, and a secured virtual local area network.

20. The docking station of claim 4, wherein the first network is in two way communication with a host device.

21. The docking station of claim 20, wherein the host device is at least one of a mobile phone app, a tablet app, a local computer, and a remote server.

22. The docking station of claim 4, wherein the docking station communicates with any one of the first network or second network using at least one of a USB, fire wire, DSL, Bluetooth®, low powered Bluetooth®, and Wi-Fi.

23. The docking station of claim 4, wherein the second network security protocols include at least one of a SSL/TLS, IPsec, SSH, AES, 3DES, IDEA, and S-HTTP.

24. The docking station of claim 4, wherein the docking station includes a cellular service receiving unit configured to allow the docking station to communicate with any one of the first network or the second network via a cellular service.

25. The docking station of claim 24, wherein the cellular service receiving unit is configured to create a wireless hotspot to provide wireless connectivity to the computerized bill presenter when the cellular service receiving unit is in communication with the cellular service.

26. The docking station of claim 4, wherein the docking station includes a near field communication (NFC) device configured to communicate with a NFC device of the computerized bill presenter, the docking station further configured to communicate an alert to a user when the computerized bill presenter is beyond a certain physical distance from the docking station.

27. The docking station of claim 4, wherein the docking station includes a user input configured to allow the user to at least one of a power OFF docking station, power ON the docking station, input any retail transaction information into the docking station, and program the docking station.

28. The docking station of claim 27, wherein the user input includes at least one of a button, an alpha-numeric keypad, and a touch screen.

29. A communication system, comprising:
a docking station having a recess configured to removably receive a portion of a computerized bill presenter;
a charging mechanism disposed in the docking station and configured to be electrically coupleable to the computerized bill presenter to charge a power source disposed in the computerized bill presenter, the charging mechanism further configurable to provide two-way communication between the computerized bill presenter and the docking station; and
a communications module configured to provide two-way communication between the docking station and a first network, the communications module further configured to provide two-way communication between the docking station and one or more computerized bill presenters over a second network, the second network including network security protocols sufficient to only allow communication between the docking station and the one or more computerized bill presenters over the second network;
the communications module further configured to provide a third network, the third network including a geofencing network configured to define a geofencing perimeter surrounding the docking station.

30. The communication system of claim 29, wherein the communications module includes a global positioning system (GPS) unit, the GPS unit configured to provide the geofencing network.

31. The communication system of claim 29, wherein the geofencing network is configured to recognize a known patron of the retail outlet within the geofenced perimeter and communicate notifications to the known patron.

32. The communication system of claim 31, wherein the notifications include at least one of a daily specials, promotions, and discounts available in the store at a given time.

33. The communication system of claim 31, wherein the notifications are communicated to the known patron using at least one of an email, text message, Facebook® status update, Twitter® feed, and Google+® alert.
